(19) United States
(12) Patent Application Publication
(10) Pub. No.: US 2009/0071770 A1
(43) Pub. Date: Mar. 19, 2009

(54) Dirt Scraper for a Disc Brake

(75) Inventors: Lars Bagge, Goteborg (SE); Jorgen Andersson, Landvetter (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 11/719,334

(22) PCT Filed: Nov. 24, 2004
(86) PCT No.: PCT/SE2004/001736

§ 371 Date: May 15, 2007

(51) Int. Cl. F16D 65/02

(52) U.S. Cl. 188/73.2

(57) ABSTRACT

A dirt scraper for a disc brake of a vehicle includes at least one scraper blade adapted to abut a braking surface of the disc for scraping off dirt when the disc rotates, and a heat sensitive structure for moving the at least one blade from a first position where it abuts the surface of the disc to a second position where it does not abut the surface of the disc, when the temperature of the heat sensitive structure increases, and vice versa.

### BACKGROUND AND SUMMARY

The present invention relates to a scraper for scraping dirt, such as mud, off the disc of a disc brake on a vehicle, such as a truck or car.

When driving a vehicle in a dirty and muddy field, the pads on a disc brake may be covered with dirt such as mud, which may reduce the braking effect due to lower friction force between the disc and the brake blocks. Furthermore, the disc may be worn due to the grinding provided by the debris or any other kind of material deposited on the disc, the grinding may be provided even if the brake is not applied, if it fills up the entire space between the disc and the brake blocks.

It is known to use protection shields for protecting the disc from dirt coming from outside, but these protection shields are not sufficient in cases where the vehicle drives off-road. Furthermore, these shields often comprise a heavy construction provided on the vehicle.

It is desirable to provide a dirt scraper for a disc brake which can remove dirt from the disc in any driving conditions, and in particular in an off-road driving condition in a dirty and muddy field.

It is desirable to provide a dirt scraper for a disc brake, which automatically abuts the disc surface when the disc is substantially cold and moves away from the disc when the disc heats up.

According to a first aspect of the invention a dirt scraper for a disc brake of a vehicle comprises;

at least one scraper blade adapted to abut the braking surface of the disc for scraping off dirt when the disc rotates, and

heat sensitive means for moving said at least one blade from a first position where it abuts said surface of the disc to a second position where it does not abut said surface of the disc, when the temperature of the sensitive means increases, and vice versa.

The dirt scraper is abutting the disc surface such that it scrapes off the dirt that may be deposited on the disc during driving, such as driving in muddy fields, which normally is done at a low speed, but also during driving at higher speeds on the highway.

If the vehicle is driving at a high speed and then brakes, the temperature of the disc increases due to the friction between the disc and the brake pads. The brakes will also heat up at low speeds if the vehicle is heavy and/or brakes hard. If the blades of the dirt scraper would abut the disc constantly, it would result in a significant wear of the blade(s). In order to avoid this wear of the blade(s), the dirt scraper comprises heat sensitive means connected to or integrated in the blade(s) such that a temperature increase, due to the braking, will force the sensitive means to move the blade(s) away from the disc and thereby avoid wear on the blade(s).

The heat sensitive means may be a material that expands when its temperature increases and retracts when its temperature decreases, or vice versa.

Preferably, the heat sensitive means comprises a bimetallic element comprising at least two laminated metals having different coefficient of thermal expansion. The scraper blade may form part of the bimetallic element, such that a layer of the bimetallic element is a part of the scraper. The bimetallic element is preferably positioned in closed vicinity to the disc such that a proper heat transfer is provided between the disc and the bimetallic element.

Preferably, the scraper comprises two scraper blades, one positioned on each side of the disc, but there may be more than two scraper blades per disc. Preferably, means is provided for attaching the dirt scraper to a stationary part of the vehicle.

The sensitive means is preferably adapted to move the scraper blades away from the disc, such that the distance between the disc and the blade(s) is 0.5 mm or more.

Depending on the construction of the sensitive means, the scraper blade(s) will be moved from the first to the second position when a given temperature is reached. Preferably, the blade(s) is moved when the disc temperature and/or the temperature of the sensitive means and/or the temperature of the blade(s) reaches at least 100° C., but it may be lower or higher, such as 80° C., 120° C., 130° C., 150° C. or even higher.

When driving at low speed, e.g. in muddy fields, the friction provided between the blade(s) and disc does not cause any significant wear on the blade(s) and disc. However, when driving at higher speed, e.g. at the highway, the friction provided between the blade(s) and the disc will be larger and cause wear and tear on the blade(s) and disc. Therefore, it is preferred to move the blade(s) to the second position when driving at high speed.

In a first development, the scraper preferably comprises a heat generating friction element preferably with a high coefficient of heat transfer and which is adapted to abut the disc for providing a temperature increase. The friction element is preferably positioned adjacent to the sensitive means for providing a proper heat transfer to the sensitive means which then will move the blade(s) to the second position due to the heat generated by the friction between the friction element and the disc. Thus, the blade(s) can be moved away from the disc not only in a braking situation, but also in a driving situation at high speed. Again, depending on the construction of the sensitive means and the friction element, the scraper blade(s) will be moved from the first to the second position when a given temperature is reached, due to the frictional heat provided between the friction element and the disc, when the disc rotates. Preferably, the scraper is moved to the second position when the disc rotates with a number of revolutions corresponding to a vehicle velocity of 20 km/h, but it may be more or less, such as 10 km/h, 30 km/h, 40 km/h, 50 km/h, 60 km/t or more.

In a second development, the speed of the vehicle is sensed the scraper is moved to the second position depending on the actual speed of the vehicle. This can be done by incorporating a heating element, such as an electrical resistor, in the heat sensitive means. When a predefined speed is reached, the heating element heats the heat sensitive means so that the heat sensitive means moves the scraper to the second position. The predefined speed can be the same as above.

The blade(s), the heat sensitive means and the friction element may be formed as one single integrated part, or they may be detachable from each other. The blade(s) and heat sensitive means is preferably provided as an integrated unit, and the blade(s) and friction element is preferably mounted detachable to the vehicle, so that it is easy to replace them by new ones when they are worn down.

The blade(s) may be made of any suitable wear-resistant material and preferably, the blade(s) is made of metal or a composite material, but it may also be made of a plastic material.

The friction element is preferably made of a composite material.

Preferably, the end of the blade(s) abutting the disc surface is made of a metal or rubber composition.

The blades may be positioned in front of and/or behind the axle to which the disc is mounted when seeing in the travelling direction of the vehicle.

The blades preferably extends from the axle to the periphery of the disc, and the blades may be tilted a given angle in relation to horizontal, so that the dirt will slide off the blade automatically.

According to a second aspect, the present invention relates to a disc brake for a vehicle comprising a dirt scraper according to the first aspect.

According to a third aspect, the present invention relates to a vehicle comprising a disc brake with a dirt scraper according to the first aspect. The vehicle according to the first, second and third aspect may be a car, truck, construction vehicle, bus, train, motorcycle or bicycle.

### BRIEF DESCRIPTION OF DRAWINGS

The invention will be described in greater detail in the following, with reference to the embodiments that are shown in the attached drawings, in which

FIG. 1 shows a disc brake with a dirt scraper according to the invention,

FIG. 2 shows a front view of the disc brake according to FIG. 1,

FIG. 3 shows an alternative embodiment of an inventive disc brake,

FIG. 4 shows a front view of the disc brake according to FIG. 3, and

FIGS. 5-8 shows alternative embodiments of a dirt scraper according to the invention.

### DETAILED DESCRIPTION

The embodiments of the invention with further developments described in the following are to be regarded only as examples and are in no way to limit the scope of the protection provided by the patent claims.

FIG. 1 shows a disc brake comprising a disc 1 and a brake calliper 2. The dirt scraper 3 is attached to the vehicle (not shown) and comprises a scraper blade 4 and a heat-sensing element in the form of a bimetallic element 5. The bimetallic element is attached to the stationary brake calliper 2. The disc 1 is moving in the direction 12.

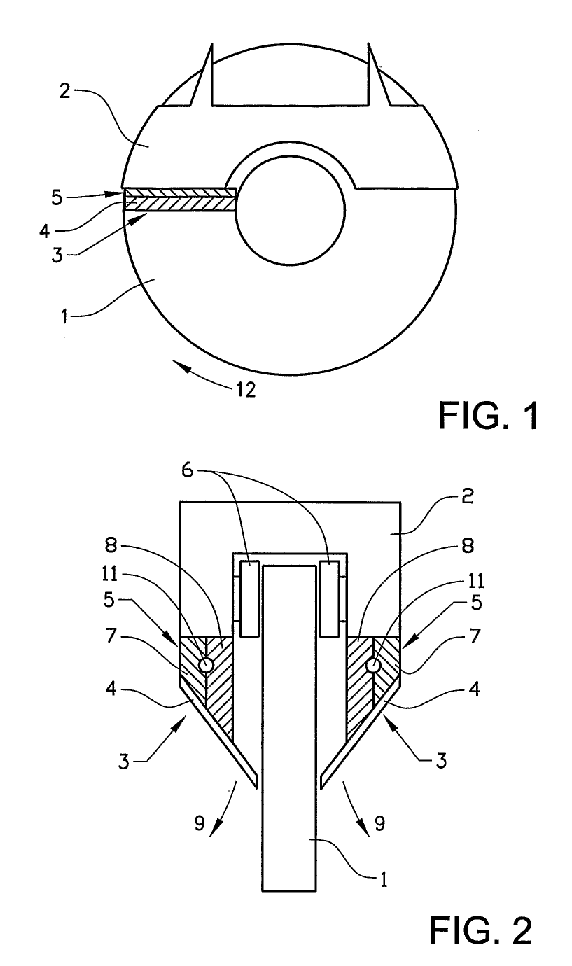

FIG. 2 shows a front view of disc brake comprising a brake calliper 2 and two brake pads 6 to be pressed towards the disc 1 for obtaining a braking effect. Two dirt scrapers 3 are attached to the brake calliper 2, one on each side, and comprise a bimetallic element 5 consisting of two metals 7, 8 having different coefficient of thermal expansion and a scraper blade 4 mounted to the bimetallic element 5. The bimetallic element also comprises a heating element 11 in the form of an electrical resistor.

When the brake pads are pressed towards the disc, said disc is heated and the generated heat will heat up the bimetallic element 5, which then expands. Since the two metals 7, 8 have different coefficients of thermal expansion, the bimetallic element 5 will expand unsymmetrical. In this example, element 8 expands more than element 7. The result will be that the scraper blade 4 is pushed outwards, and thereby the scraper blade is turned away from the disc 1 in the direction 9.

In order to move the scraper blade when the disc is not warm, the heating element 11 may be activated to heat the bimetallic element 5. The activation of the heating element 11 may be conducted at different occasions, but is preferably done when the vehicle is travelling over a predetermined speed. It is also possible to activate the heating element when the vehicle is travelling outside a predefined area, e.g. when the vehicle is outside of a construction site. The heating element is in this example a resistor that is heated by an electrical current. The heating element may have a fixed resistance or may be of a self-regulating type with a built in temperature-controlling device. The heat for moving the scraper blade 4 may also be generated by friction provided between the scraper blade 4 and the disc 1, e.g. with a friction element as shown in FIG. 6.

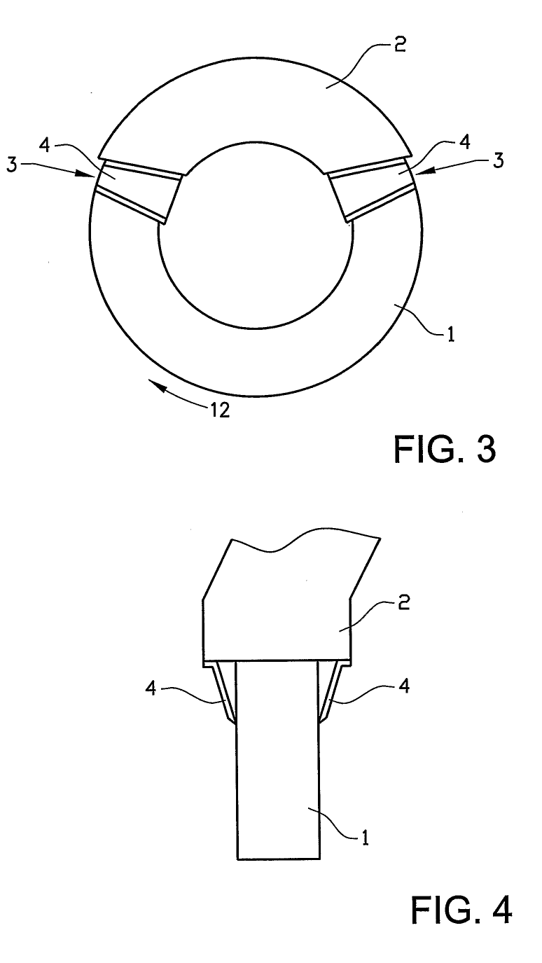

FIGS. 3 and 4 show a disc brake with two dirt scrapers 3 positioned on each side of a disc 1 and mounted to a brake calliper 2. Each dirt scraper 3 comprises an angled scraper blade 4. This embodiment is advantageous for a construction vehicle, since the dirt scrapers will remove dirt also when the vehicle is moving backwards. The disc is moving ion the direction 12.

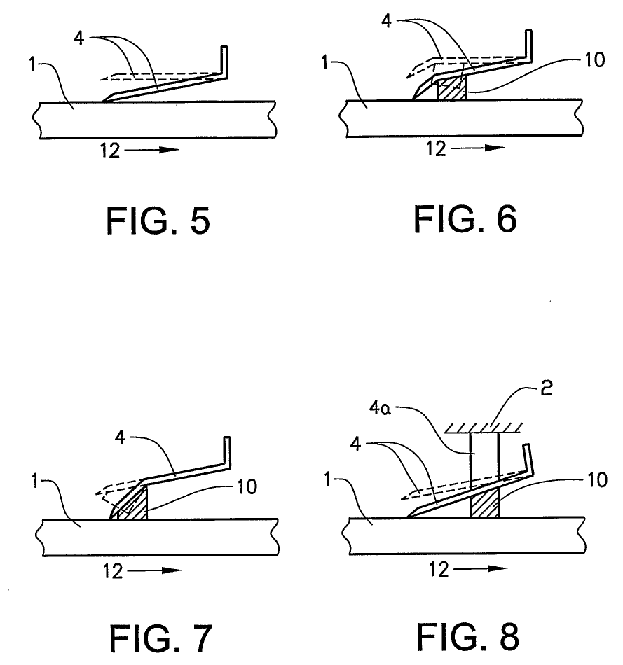

FIGS. 5-8 shows different embodiment of the dirt scraper according to the invention. In FIG. 5 is shown a dirt scraper comprising a scraper blade 4 that can move between a first position where it abuts the disc 1 and a second position where it does not abut the disc 1, the disc rotating in the direction 12. The scraper blade 4 is here integrated with the heat sensitive means, preferably a bimetallic element, which actuates the movement of the blade when heat is generated in the disc.

The dirt scraper of FIG. 6 further comprises a heat generating friction element 10 provided on the scraper blade 4. The element 10 abuts the disc 1 for generating frictional heat to be transferred to the bimetallic element integrated in the scraper blade 4 for moving the blade away from the disc 1. In this embodiment, the entire scraper blade 4 is moved.

The dirt scraper of FIG. 7 is almost identical to the one of FIG. 6 despite that it is only the tip of the scraper blade 4 that is moved, as the bimetallic element is provided therein. The friction element 10 is provided on the tip of the blade 4.

In the dirt scraper of FIG. 8, a bimetallic element 4a is provided between a stationary part 2 of the vehicle and the scraper blade 4, which may be made of spring steel. The heat generating friction element 10 is positioned opposite to the bimetallic element between the blade 4 and the disc for generating heat to the bimetallic element, so as to lift the blade away from the disc.

The invention is not to be regarded as being limited to the embodiments described above, a number of additional variants and modifications being possible within the scope of the subsequent patent claims. The scraper can also be used for other rotating members where a selective scraping action is desirable.

1. A dirt scraper for a disc brake of a vehicle, the scraper comprising:
at least one scraper blade adapted to abut a braking surface of the disc for scraping off dirt when the disc rotates, and
heat sensitive means for moving the at least one blade from a first position where it abuts the surface of the disc to a second position where it does not abut the surface of the disc, when the temperature of the sensitive means increases, and vice versa.

2. A scraper according to claim 1, wherein the heat sensitive means comprises a material that expands when its temperature increases and contracts when its temperature decreases, or vice versa.

3. A scraper according to claim 1, wherein the heat sensitive means comprises a bimetallic element comprising at least two laminated metals having different coefficients of thermal expansion.

4. A scraper according to claim 3, wherein the at least one scraper blade forms part of at least one of the two laminated metals.

5. A scraper according to claim 1, wherein the scraper comprises two scraper blades, one positioned on each side of the disc.

6. A scraper according to claim 1, wherein the distance between the disc and the at least one scraper blade, when the at least one scraper blade is in its second position, is at least 0.5 mm.

7. A scraper according to claim 1, wherein the at least one scraper blade is moved away from the disc when the temperature of the sensitive means reaches at least 30° C.

8. A scraper according to claim 1, wherein the scraper comprises a friction element adapted to abut the braking surface of the disc for generating heat for providing the temperature increase when the disc rotates.

9. A scraper according to claim 1, wherein the scraper is adapted to move away from the disc when the disc rotates with a number of revolutions corresponding to a vehicle velocity of minimum 20 km/h.

10. A scraper according to claim 8, wherein the friction element is made of a composite material.

11. A scraper according to claim 1, wherein the scraper comprises a heating element adapted to heat the heat sensitive means.

12. A scraper according to claim 11, wherein the scraper is adapted to move away from the disc when the vehicle velocity is greater than a predetermined value.

13. A scraper according to claim 1, wherein the at least one scraper blade is made of at least one of metal, plastic material, and a composite material.

14. A scraper according to claim 1, wherein at least the end of the at least one blade abutting the disc surface is made of rubber.

15. A scraper according to claim 1, wherein the blades are positioned at least one of in front of and behind an axle to which the disc is mounted when viewed in a travelling direction of the vehicle.

16. A scraper according to claim 1, comprising means for attaching the dirt scraper to a stationary part of the vehicle.

17. A disc brake for a vehicle comprising a dirt scraper according to claim 1.

18. A vehicle comprising a disc brake with a dirt scraper according to claim 1.

19. A vehicle according to claim 18, wherein the vehicle is a car or truck or construction vehicle or bus or train or motorcycle.
